(19) United States
(12) Patent Application Publication
(10) Pub. No.: US 2007/0144949 A1
(43) Pub. Date: Jun. 28, 2007

(54) METHOD AND APPARATUS FOR TESTING MEMBRANE INTEGRITY

(76) Inventor: Hidayat Husain, Oakville, ON (CA)

Correspondence Address: BERESKIN AND PARR, 40 KING STREET WEST, BOX 401, TORONTO, ON, M5H 3Y2, CA

(21) Appl. No.: 11/565,964

(22) Filed: Dec. 1, 2006

Related U.S. Application Data
(60) Provisional application No. 60/741,551, filed on Dec. 2, 2005.

(51) Int. Cl. G01N 15/08; B01D 35/143

(52) U.S. Cl. 210/90; 73/38

(57) ABSTRACT

A portable or handheld testing apparatus for testing the integrity of membranes in a water treatment unit includes a pressurized gas supply element for pressurizing one side of membranes of a water treatment unit; a pressure sensor in communication with the gas on said one side of the membranes for sensing the pressure thereof; a controller in communication with the pressure sensor for comparing signals from the pressure sensor to pre-selected acceptance criteria; and an output device in communication with the controller for signaling results of the comparison.

This application claims the benefit of Provisional Application No. 60/741,551, filed Dec. 2, 2005, which is incorporated herein by reference.

### FIELD

The present specification relates to, among other things, a method or apparatus for testing the integrity of membranes, for example membranes in a water filtration system for residential household application.

### BACKGROUND

Filtering membranes can be used to purify water by permeating water from a feed side to a delivery side of a porous membrane. The size of the pores can be sufficiently small to remove very small particles including pathogenic microorganisms and colloids. However, if the integrity of the membrane is breached, such as by a tear, rupture, or the presence of enlarged openings, the filtering effectiveness may be compromised. Such breaches or leaks can be caused by, for example, fatigue, over-pressurization, or from damage caused during cleaning or maintenance. It can therefore be desirable to regularly test the integrity of the membranes. Some leak test systems are disclosed in U.S. Pat. No. 5,353,630 (Soda et al.) and U.S. Pat. No. 5,918,264 (Drummond et al.)

Integrity test systems are used in large filtration systems, such as industrial or municipal installations, and are a permanent component of the installation. Large facilities in which integrity test systems are installed have existing compressors or the like for supplying pressurized gas which can be tapped for use in the testing system. As well, such facilities generally have on-site technicians able to initiate and/or monitor the integrity testing operation, and to interpret and/or react to the results as required.

### SUMMARY

The following summary is intended to introduce the reader to this specification but not to define any invention. In general, the applicant's teaching discloses one or more methods or apparatuses for providing an integrity test of membranes, for example membranes that may optionally be used in point of entry filtration assemblies. In some examples, the apparatus may be handheld, portable, weigh less than 20 pounds or have a volume of less than 1 cubic foot. In other examples, the testing apparatus or elements thereof may be permanently installed with a filtration assembly, and an integrity test procedure may be remotely activated by a signal received from a remotely located master controller. Indication signals collected and/or generated as a result of the test procedure may be sent from a local controller at the filtration assembly to the master controller at a service center.

According to one aspect of the applicant's teaching, a testing apparatus for testing the integrity of membranes in a water treatment unit comprises a pressurized gas supply element for pressurizing one side of membranes of a water treatment unit; a pressure sensor in communication with the gas on said one side of the membranes for sensing the pressure thereof; a controller in communication with the pressure sensor for comparing signals from the pressure sensor to pre-selected acceptance criteria; and an output device in communication with the controller for signaling results of the comparison.

The testing apparatus can include a housing, and at least the pressurized gas supply element and the controller can be housed in the housing. The pressurized gas supply element can include an air pump. The air pump can be switchable between on and off positions by electrical communication from the controller.

The controller can include at least one stored algorithm, execution of which can be triggered by an initiate signal sensed by the controller. The algorithm can include turning the pump off and sensing the pressure at least before and after a time interval, and the acceptance criteria can include comparing the difference between the before and after pressures to a pre-set maximum allowable pressure drop. The algorithm can include, prior to turning the pump off, turning the pump on and sensing the pressure at least once to confirm satisfactory pressurization of said one side of the membranes.

A method for providing treated water in multiple homes or buildings using membrane filtration may comprise steps of installing respective ones of a plurality of filtration systems at respective ones of a plurality of water service entry points, the filtration systems including porous membranes through which water is directed; providing an integrity tester apparatus, the tester apparatus connectable to any one of the plurality of filtration systems; and connecting the integrity test apparatus one at a time to each of the plurality of filtration systems to test the integrity of the membranes.

The respective ones of the plurality of water service entry points can be remote from each other, and the method can include transporting the tester apparatus between each of the water service entry points. The tester apparatus can include an integral air pump, and the method can include releasably coupling the air pump to the respective ones of the plurality of filtration systems to provide pressurized gas on one side of the membranes.

A system for providing a plurality of water service entry points with filtration assemblies and testing the integrity thereof may comprise a plurality of filtration assemblies, each assembly adapted for installation at a respective water service entry point, each filtering unit having porous membranes; and an integrity test apparatus releasably connectable to any one of the plurality of filtration assemblies to test the integrity of the membranes.

The integrity test apparatus can be portable, and the integrity test apparatus can be handheld. The integrity test apparatus can include a pressurized gas supply element. The pressurized gas supply element can include an air pump. Each of the filtration assemblies can include a test connector element for releasable connection to the test apparatus.

According to another aspect, a system for providing a plurality of water service entry points with filtration assemblies and testing the integrity thereof, comprises a plurality of filtration assemblies, each filtration assembly having porous membranes through which feed water from a respective water supply line is passed; a plurality of integrity test apparatuses, each integrity test apparatus coupled to a respective one of the filtration assemblies for testing the integrity of the membranes; and a master controller coupled to each one of the integrity test apparatuses.

Each one of the integrity test apparatuses can comprise a local controller having an interface for communication with the master controller. Each one of the integrity test apparatuses comprises a respective pressure sensor for sensing pressure on a first side of the membranes, the respective pressure sensor in communication with the respective local controller. Each one of the integrity test apparatuses can comprise a respective gas supply element for pressurizing the first side of the membranes in response to a signal received from the respective local controller. Each one of the filtration assemblies can comprise at least one valve movable between first and second positions in response to a signal received from the respective local controller.

The system can include steps in a test procedure stored as instructions in each respective local controller, the stored instructions including instructions for receiving signals from the respective pressure sensor and for sending signals to the gas supply element and at least one valve. The system can include test acceptance criteria stored in each respective local controller for comparison to signals received from the respective pressure sensor. The system can include test-triggering criteria stored in each respective local controller for initiating execution of the steps of the test procedure.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the applicant's teaching disclosed herein and are not intended to limit the scope of what is taught in any way. In the drawings:

FIG. 1 is a schematic view of a water quality system showing a water filtration assembly and a testing apparatus coupled to the water filtration assembly;

FIG. 2 is a front view of the testing apparatus of FIG. 1;

FIGS. 3 and 3a are a photograph and a schematic view, respectively, of the testing apparatus of FIG. 1;

FIGS. 4 and 5 are flow charts of an algorithm of the testing apparatus of FIG. 1;

FIG. 6 is a schematic view of the filtration assembly of FIG. 1 showing further details thereof;

FIG. 7 is an enlarged elevation view of a portion of the filtration assembly of FIG. 6;

FIG. 8 is a schematic drawing showing a plurality of water filtration assemblies and a testing apparatus for coupling to any one of the water filtration assemblies;

FIG. 9 is a schematic view of another example of a water system having a filtration assembly and a testing apparatus;

FIG. 10 is a schematic view of the testing apparatus of FIG. 9; and

FIG. 11 is a schematic view showing a plurality of water filtration assemblies in communication with a service center.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

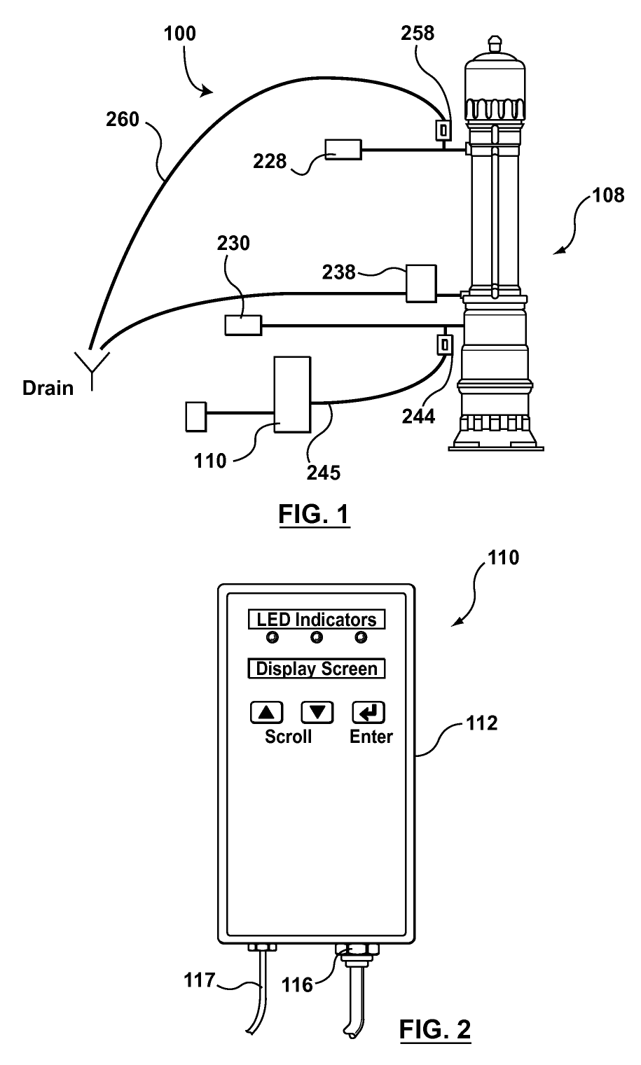

A water quality system 100, including a water filtration assembly 108 and a testing apparatus 110, is shown in FIG. 1. The testing apparatus 110 can be used for testing the integrity of membranes in the water filtration assembly 108, as described in greater detail subsequently herein.

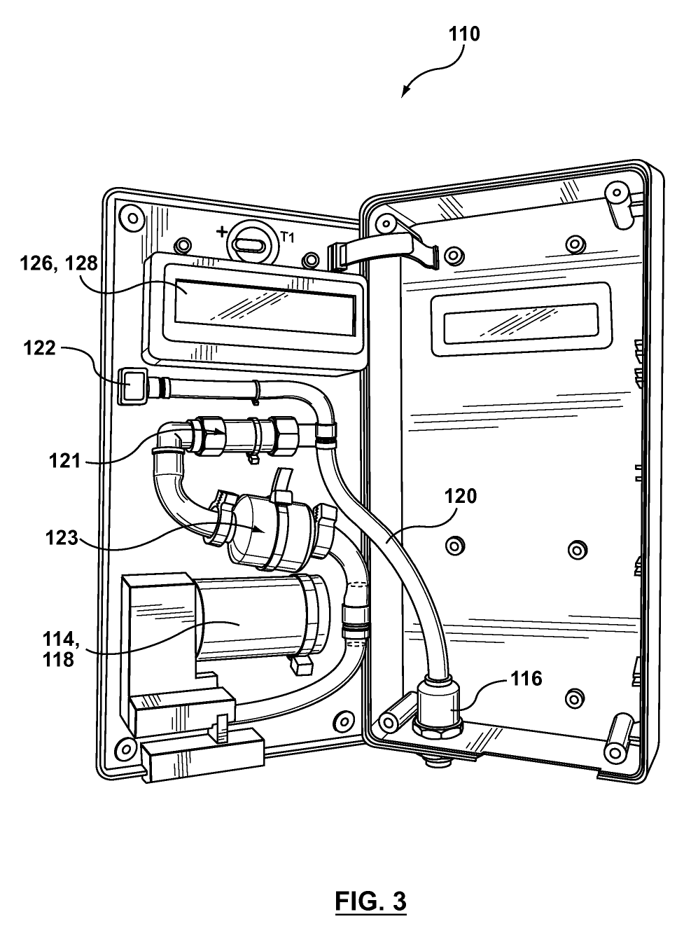

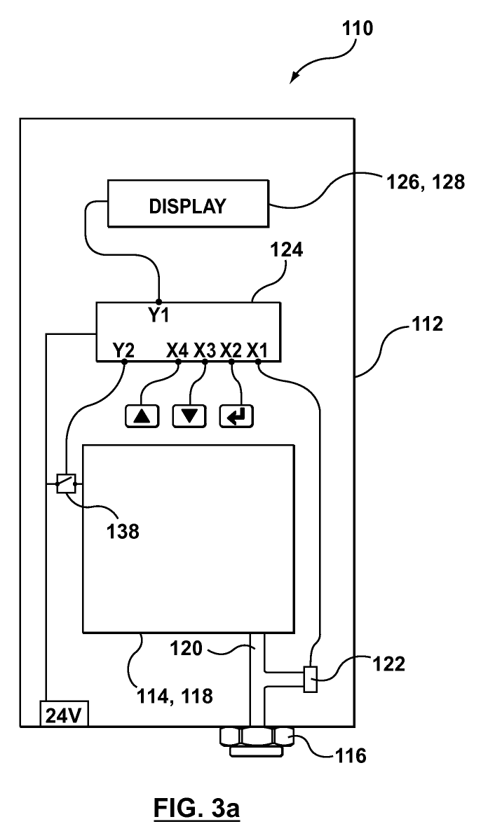

Referring to FIGS. 2, 3, and 3a, the testing apparatus 110 includes a housing 112 and a gas supply element 114 mounted in the housing. The gas supply element 114 can provide a pressurized supply of gas to a gas supply port 116 fixed in a wall of the housing 112. In the example illustrated, the gas supply element 114 is in the form of an air pump 118. The air pump 118 delivers pressurized air to the gas supply port 116 via a conduit 120.

The testing apparatus 110 is further provided with a pressure sensor 122 for measuring the pressure of the gas downstream of the air supply element 114. In the apparatus illustrated, the pressure sensor 122 is in fluid communication with the conduit 120. A check valve 121 and an air filter 123 can be disposed in the conduit 120, between the pressure sensor 122 and the gas supply element 114.

The testing apparatus 110 has a controller 124 for receiving signals from the pressure sensor 122. The controller 124 can be provided with pre-selected pressure values against which signals from the pressure sensor 122 can be compared. In the apparatus illustrated, the pre-selected values form part of one or more acceptance criteria stored in the controller 124.

An output device 126 is provided in communication with the controller 124 for signaling results of the comparison of signals from the pressure sensor 122 with the pre-selected acceptance criteria. In the apparatus illustrated, the output device 126 includes a display screen 128.

The controller 124 can be an electronic device containing a stored algorithm and a plurality of inputs X1, X2, . . . and outputs Y1, Y2. . . for respectively providing signals to and receiving signals from the controller 124. In the apparatus illustrated, the sensor 122 is electrically connected to input X1 of the controller 124. Keys (enter key 130, scroll up key 132, and scroll down key 134) of a keypad are connected to inputs X2, X3 and X4, respectively. The output device 126 is connected to output Y1 of the controller 124. Output Y2 is connected to a relay or switch 138 for turning the pump 118 on or off.

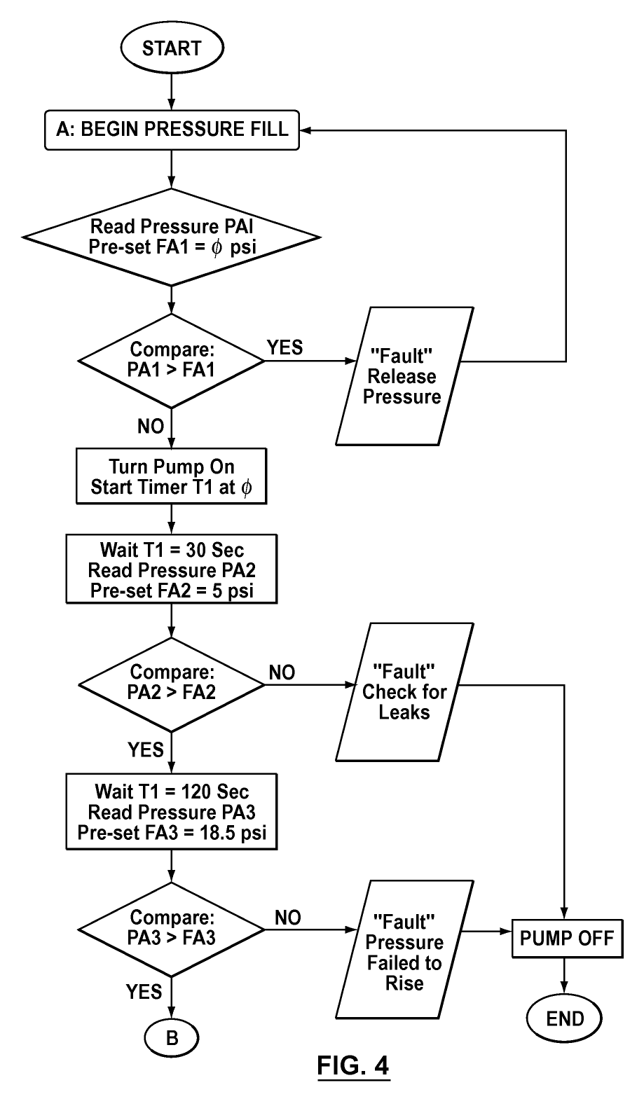

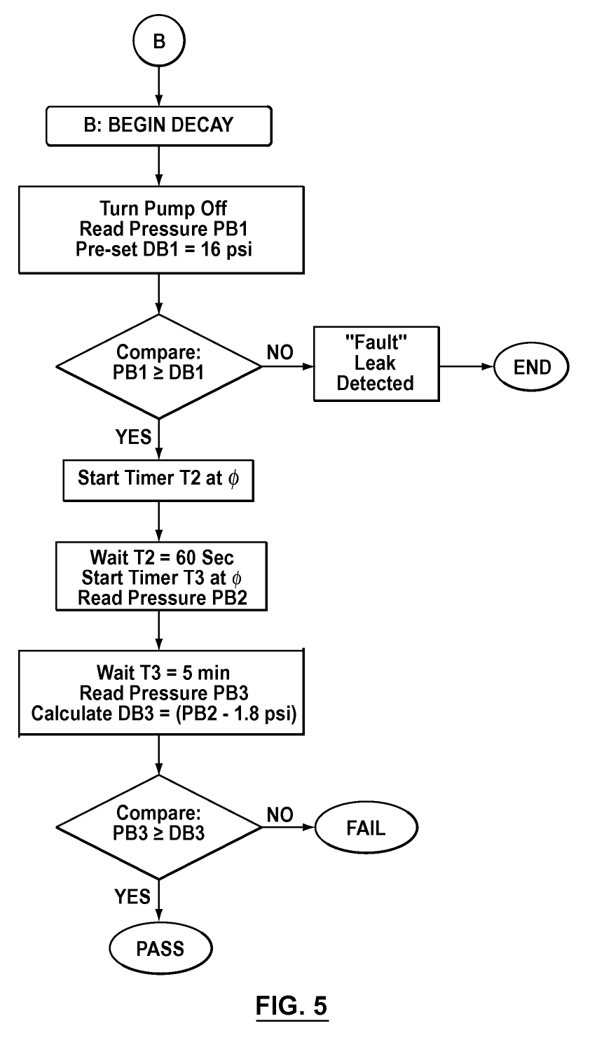

An example of an algorithm for storage in the controller 124 can best be understood with reference to the flow charts in FIGS. 4 and 5. The algorithm or testing sequence includes two main parts: part A is a pressurization or filling sequence in which pressurized air is delivered to one side of the membranes of a filtration unit. Part B is a decay sequence in which the pressure is permitted to drop, and the rate of the pressure drop is analyzed to verify the integrity of the membranes. Parameters or other values in this method may be chosen to be appropriate to test a filtration system of known design to a certain standard, for example a log removal or maximum defect size standard set by legislation, contract standard, reasonableness or removal of particles of a certain size.

In Part A, and with reference to FIG. 4, the pressurization sequence is monitored to confirm satisfactory pressure build-up prior to initiating the decay sequence. The pressure level is read (via sensor 122) three times, corresponding to PA1, PA2, and PA3, and compared to pre-set values FA1, FA2, and FA3. The comparison to FA1 is a pre-check, to ensure that the filtration system has been depressurized in preparation for the integrity test. Thus, the pre-set value FA1 can be set at a low value, such as 0 or 1 psi.

The comparison to FA2 is an early fill check to ensure that pressure is rising normally. The value of FA2 can be about 5 psi, and checked after a given amount of time, such as about 30 seconds of pump operation. Failure to reach the FA2 pressure within the given time can be evidence of a large leak, such as a connection failure.

The comparison to FA3 is a final check to ensure that a target pressure has been satisfactorily obtained. In the example illustrated, the target pressure value FA3 is set at about 18.5 psi.

Once the target filling pressure FA3 has been obtained, the decay sequence (part B—FIG. 4) can begin. The controller 124 sends a signal to switch 124 to turn off the pump 118. The pressure during decay is read three times (PB1, PB2, PB3) to monitor the decay.

The first decay pressure reading PB1 is taken immediately after turning off the pump 118, and compared to an initial decay pressure DB1 to ensure that the pressure did not drop excessively during pump turn-off. The pre-set value DB1 can be set below the target fill pressure FA3, but high enough to provide a starting pressure that will show a detectable decay over a reasonable amount of time. In the process illustrated, DB1 was set at 16 psi.

After a stabilization delay, the reading PB2 is taken, to serve as the pre-decay pressure value. After a fixed decay time has elapsed (e.g. 5 minutes), the final post-decay pressure PB3 is read. The difference between the readings PB2 and PB3 indicates the pressure drop over the decay time period. In the process illustrated, a pressure drop of less than 1.8 psi indicates that the membranes are in satisfactory condition. In other words, a measured post-decay pressure that is greater than or equal to a minimum allowable pre-set value DB3 (where DB3 equals the pre-decay pressure value PB2 less 1.8 psi) indicates satisfactory membrane condition.

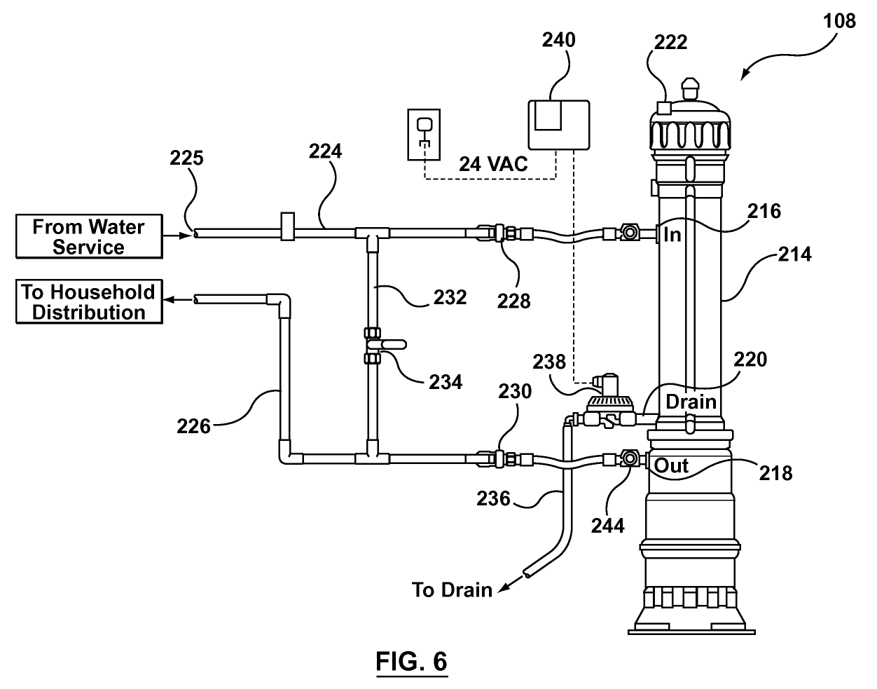

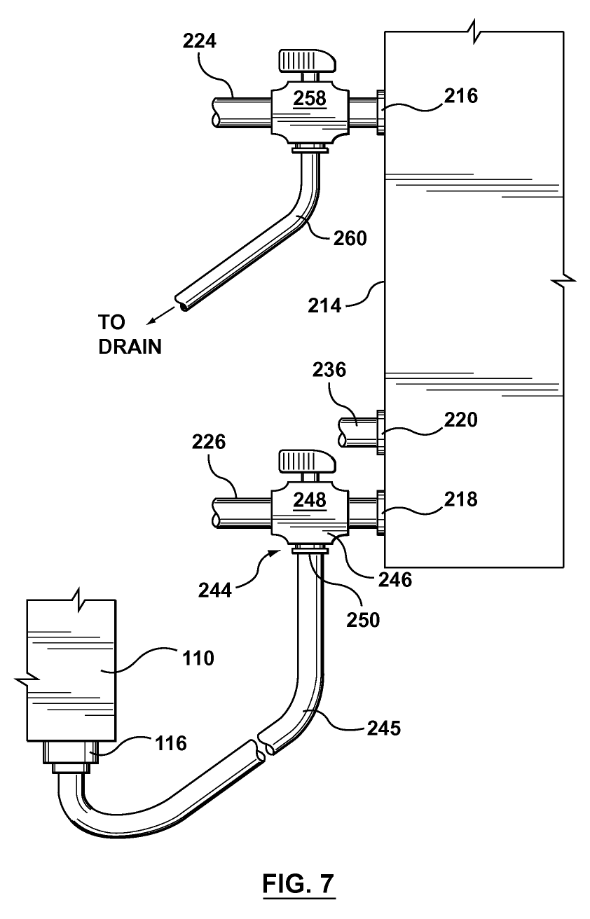

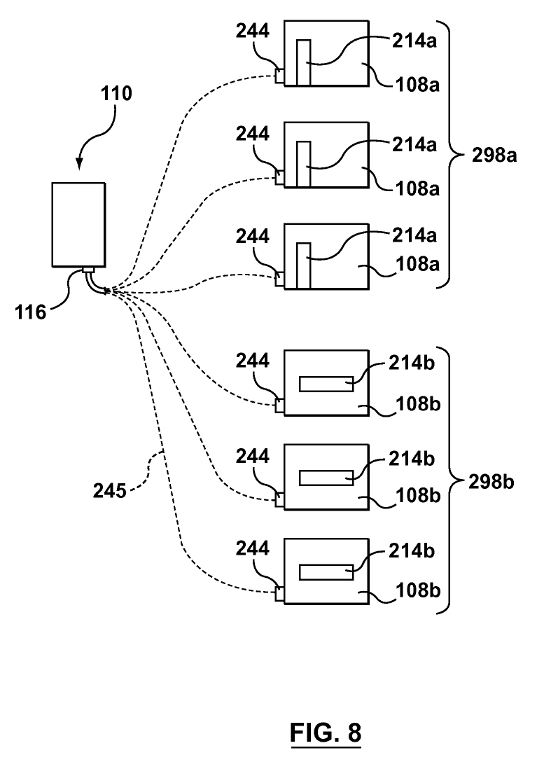

Details of the filtration assembly 108 configured for use with the testing apparatus 110 and in accordance with an example of the applicant's teaching can be seen in FIGS. 1 and 6. The assembly 108 includes a filtering unit 214 having a feed port 216 for receiving water to be filtered and a delivery port 218 for delivering filtered water. The filtering unit 214 further includes a drain port 220 for draining and/or flushing the filtering unit 214, and an air vent 222 to provide pressure/vacuum relief when filling/draining the filtering unit 214.

The filtration assembly 108 can be connected to, for example in line with, the plumbing of a home or building so that water provided to the home or building passes through the filtering unit 214 before being distributed to faucets, appliances, or the like within the home or building. In the system illustrated, the filtration assembly 108 includes a feed conduit 224 that conveys water to be filtered from a point of entry 225 (e.g. generally where a municipal water service line enters the building) to the feed port 216 of the filtering unit 214. A delivery conduit 226 extends from the delivery port 218 for distribution of filtered water within the home or building.

The filtration assembly 108 need not filter all the water distributed to a home. For example, the assembly 108 can be located near the water service entry point 225, but one or more lines may branch off upstream of the assembly 108 to distribute unfiltered water to outlets, for example, exterior taps, laundry tub faucets, or other locations where filtered water is not required or desired.

The filtration assembly 108 can be provided with a feed shut-off valve 228 and a delivery shut-off valve 230 in the feed and delivery conduits 224, 226, respectively, for selectively allowing or blocking flow therethrough.

The assembly 108 can further include a bypass conduit 232 extending between the feed and delivery conduits 224, 226 and positioned upstream and downstream, respectively, of the shut-off valves 228 and 230. The bypass conduit 232 can have a bypass shut-off valve 234.

A drain conduit 236 can extend from the drain port 220 to a drain in the home or building, such as a floor drain. A drain valve 238 can be disposed in the drain conduit 236. The drain valve 238 can be electronically controlled by, for example, a drain controller 240, for automatically conducting a drain and/or flush procedure.

Housed within the filtering unit 214 is a plurality of membranes. The membranes can be in the form of hollow fiber membranes having porous cylindrical walls through which water passes when traveling from the feed port 216 to the delivery port 218. Further details of examples of membrane configurations suitable for use within the filtering unit 214 are disclosed in U.S. Pat. No. 6,589,426 issued Jul. 8, 2003 to Husain et al., which is incorporated herein in its entirety.

The filtration assembly 108 is, in the example illustrated, further provided with a tester connector element 244 for releasable attachment of the testing apparatus 110 thereto, for checking the integrity of the membranes of the filtering unit 214. The connector element 244 can facilitate connection of an air delivery conduit 245 to the assembly 108 for providing pressurized air on one side of the membranes, as part of an air leak test.

The connector element 244 can provide fluid communication with at least one of the feed and delivery ports. In the example illustrated, the connector element 244 is provided in the form of an attachment port 246 of a connector valve 248 disposed in the delivery conduit 226, between the delivery port 218 and the delivery shut-off valve 230. The connector element 244 can include a quick release connection element such as a releasable press-fit fitting 250 disposed in the port 246. In the system illustrated, the connector element 244 is configured to releasably receive an end 252 of the conduit 245. The conduit 245 can be in the form of a length of plastic tubing.

The connector valve 248 can be a mini-ball valve, movable between open and closed positions. In the open position, the connector valve 248 permits fluid flow between its three ports, and in the closed position, flow between the three ports is shut-off. A plug (not shown) can be inserted in the port 246 when flow from the delivery port 218 to the delivery conduit 226 is desired, but no testing is to be performed. Alternatively, the valve 248 can be a two-position, two-way valve, movable between a first (filtering) position and a second (testing) position. The filtration assemblies 108 are adapted for installation in respective ones of a plurality of homes and/or other buildings. It is generally desired (if not required by law) that the filtration units be tested periodically to, for example, verify the integrity of the membranes.

Some aspects of the teaching disclosed herein provide methods for providing integrity tests for multiple filtration assembly installations that can be remote from each other in which at least some or all of the elements of the test equipment need not be permanently installed with each filtration assembly.

A trained technician can carry a testing apparatus 110 to a particular filtration assembly 108 installed in a particular home or building. The technician can couple the testing apparatus 110 to the assembly 108 by inserting one end of the air supply conduit 245 in the connector element 244 of the assembly 108, and the other end in the port 116 of the testing apparatus 110. The valve 248 can be opened. A power cord 117 can be plugged into an outlet to provide power to the apparatus 110.

The technician can drain the filtering unit 214 in preparation for the integrity test, by closing the inlet and outlet valves 228, 230, and opening the drain valve 238. A backflow valve 258 can be provided in the feed conduit 224 intermediate the feed port 216 and the inlet valve 228, for draining water displaced during the test. The back flow valve 258 can be opened, and a back flow line 260 can be secured thereto for directing displaced water from the filtering unit 214 to a drain.

The integrity test can then be performed, as described previously. The test can be initiated, for example, by scrolling through the functions using the up and down arrow keys (inputs X4 and X3), until “start test” is displayed, and then pressing the enter key (input X2). Once the test sequence is completed, the technician can, if the test results show a “pass”, document the results and take note of when the system 108 is next scheduled to be re-tested. If the test results show a “fail”, the technician can take corrective action and re-test the assembly 108 as necessary.

The technician can disconnect the testing apparatus 110 and return the system to normal operating mode (by adjusting the valves, etc), and then travel to the next system location, bringing the testing apparatus 110 along to check the next assembly 108.

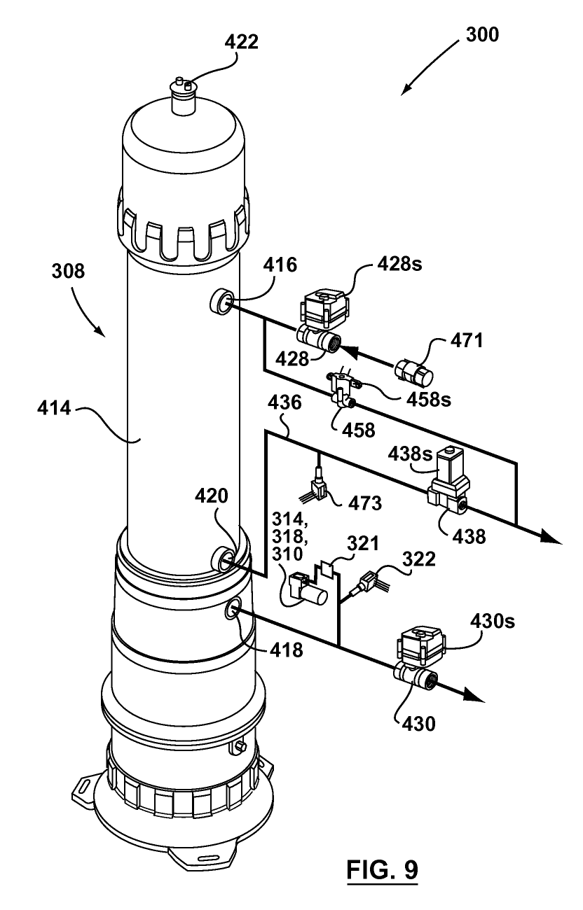

With reference to FIG. 9, the plurality of filtration assemblies 108 can include first and second groups 298a and 298b of filtration systems 108a and 108b. The filtration systems 108a can be generally the same as the filtration assemblies 108. The filtration systems 108b can be for similar use as the systems 108, 108a, but with some modifications. For example, the systems 108a and 108b can have respective filtering units 214a and 214b of different size or shape. Each system 108a illustrated has a generally vertically oriented filtering unit 214a, and each system 108b has a generally horizontally oriented filtering unit.

A single testing apparatus 110 can be coupled to any one of the filtration systems 108a or 108b of the groups 298a and 298b. Each of the systems 108a and 108b have a common connection element 244 for receiving an end of the air supply conduit 245.

The distinct systems 108a and 108b can require distinct test algorithms. For example, unique pre-set values may be required for the system 108a as compared to the system 108b. Alternatively, or additionally, different timing or different steps entirely may be required. The testing apparatus 110 can be provided with distinct algorithms stored in the controller 124 to accommodate the different systems 108a and 108b. For example, a first algorithm can be stored in the controller 124 for systems 108a, and a second unique algorithm can be stored in the controller 124 for systems 108b. The algorithm can be selectable, for example, by a technician operating the testing apparatus 110. By identifying the type of system, the corresponding algorithm can be selected and the testing apparatus 110 can be used regardless of which system 108a, 108b is to be tested.

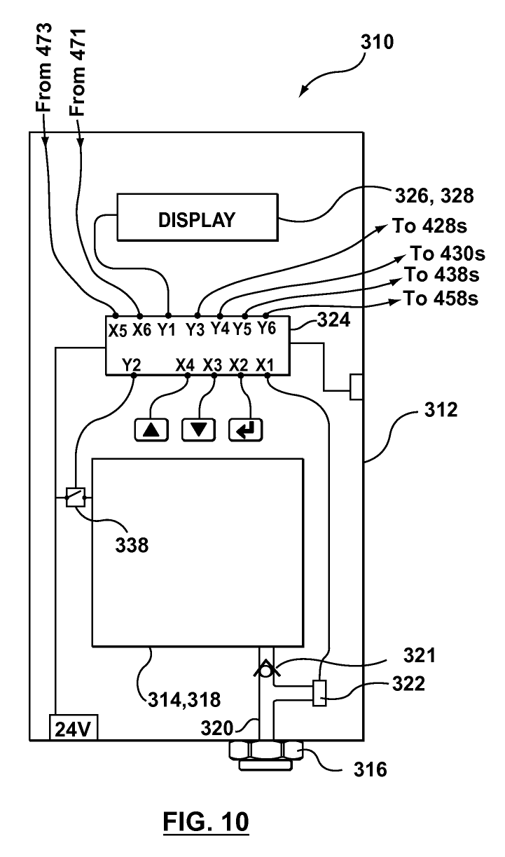

Another example of a water quality system 300 comprising a water filtration assembly 308 and a testing apparatus 310 can be seen in FIGS. 9-11. The water quality system 300 is similar to the system 100, and like elements are identified with like reference characters, incremented by 200.

The water filtration assembly 308 includes a filtering unit 414 having a feed port 416, a delivery port 418 and a drain port 420. A plurality of hollow fiber membranes are housed within the filtering unit 414. Feed water entering the feed port 416 is directed to flow through the walls of the hollow fiber membranes before exiting via the delivery port 418. In the example illustrated, the feed port 416 of the assembly 308 is open to the interior (lumen side) of the membrane walls, and the delivery port 418 is open to the exterior (casing side) of the membrane walls. The drain port 420 is, in the example illustrated, also open to the casing side of the membrane walls.

In the system 300, the feed shut-off valve 428, delivery shut-off valve 430, and drain valve 438 can be moved between respective positions (for example, between open and closed positions), by signals sent from the controller 324 of the testing apparatus 310. For example, each valve 428, 430, and 438 can comprise a respective solenoid 428s, 430s, and 438s for actuating the respective valve. The solenoids 428s, 430s, and 438s can be in electrical communication with the controller 324 via outputs Y3, Y4, and Y5 (respectively) of the controller 324. The backflow valve 458 can also be actuated by means of a solenoid 458s which is, in the example illustrated, in electrical communication with the controller 324 via output Y6.

The signal-actuated valves 428, 430, 438, 458 can facilitate running the test algorithm by having the controller 324 automatically open and close the valves for draining the filtering unit 414, filling the lumens with air, and returning the system 300 to normal operating mode after passing the test. For example, the technician can select a “start test” function in the controller 324 (using the up/down arrow keys and pressing the enter key) to send a start signal to the controller 324. The controller 324 can then automatically move the valves 428, 430, 438, 458 (as required) to drain the filtering unit 414, depressurize the lumens, and then start parts A and B of the test algorithm. If the test results are satisfactory (“pass” result), the controller 324 can send signals to the valve solenoids to automatically return the system 300 to normal filtering mode.

The system 300 can also be provided with additional sensors. In the example illustrated, the system 300 includes a flow-measuring device 471 for indicating (at least approximately) the amount of water that has been filtered by the filtration assembly 308. The flow-measuring device 471 can be mounted within the feed shut-off valve 428, within the inlet port 416, or at any another suitable location in the flow path of the system 300, such as in the delivery port 418 or delivery valve 430.

The system 300 can also be provided with an additional pressure sensor 473 in fluid communication with the exterior (shell side) of the membrane walls. In the example illustrated, the additional “shell side” pressure sensor 473 is connected to the drain conduit 436 extending from the drain port 420.

The shell side pressure sensor 473 can be fixed within the housing 312 of the testing apparatus 310, and connected to a fitting in the drain conduit 436 via a removable length of tubing. Alternatively, the shell side pressure sensor 473 can be fixed to the drain conduit 436, and an electrical connector (e.g. a wire) can be plugged into the testing apparatus 310.

The shell-side pressure sensor 473 is electrically connectable to the controller 324 of the test apparatus 310, for example at input X5. The flow-measuring device 471 is electrically connectable to the controller 324, for example, at input X6.

The first lumen-side pressure sensor 322 can measure the pressure of the gas in the lumens during testing, and can also measure the pressure of liquid (e.g. water) on the lumen side of the membranes during normal filtering operation of the system 300. The check valve 321 can prevent backflow of liquid past the sensor 322 to the gas supply element 314. The two pressure sensors 322, 473 facilitate measuring the trans-membrane pressure (TMP) across the membrane walls, which can be compared to pre-selected acceptable ranges based on, for example, the size, configuration, and/or age/use of the particular filtration assembly 308.

In addition or alternately to sending a start signal to the controller 324 by using the input keys, the testing apparatus 310 can automatically send a start signal to initiate the testing procedure. The start signal can be sent to the filtration assembly 308 in response to a variety of test-triggering events. The controller 324 can monitor data including data from the sensors, and compare the monitored data to pre-selected test-triggering criteria.

For example, the test-triggering criteria can include time-based criteria, such as time since last test. For example, the controller 324 can initiate the test algorithm each time 14 days (for example) have elapsed since the last test.

The test-triggering criteria can alternatively or additionally comprise a limit on the amount of water flowing through the flow-measuring device. For example, the controller 324 can initiate the test algorithm each time 15,000 liters of water have passed through the flow-measuring device since the last test.

The test-triggering criteria can alternatively or additionally comprise a limit on the acceptable TMP as measured by comparing the signals from the lumen side pressure sensor 322 and shell side pressure sensor 473. For example, unacceptably high TMP may indicate fouled or blocked membranes, which may be cleared by the testing procedure (urging air into the lumens can backwash the membrane). An unacceptably low TMP can indicate a breach in the membrane which could comprise the removal of impurities from the water.

All or some of the components of the testing apparatus 310 can be resident with (i.e. locally installed at) the filtration assembly 308. In the example illustrated, the testing apparatus 310 as a whole is adapted for permanent installation with the assembly 308. The housing 312 can be mounted, for example, on a wall near the assembly 308. In some examples, the shell side pressure sensor 473 can be mounted in the housing 312, and connected to the drain conduit by a sensing tube. In some examples, the flow-measuring device 471 can be mounted in the housing 312, and connected in-line with an appropriate conduit (e.g. the inlet conduit) by inflow and outflow tubes on either side of the measuring device 471.

Some or all of the components of the test apparatus 310 can be mounted in close proximity to the conduits of the filtration assembly 308 with which the respective components communicate. For example, the air pump 318 and/or lumen side pressure sensor 322 can be mounted directly to the delivery conduit 426. The shell side pressure sensor 473 can be mounted directly to the drain conduit 436. Removing any direct fluid conduit connections to the housing 312 can facilitate locating the housing 312 a distance away from the assembly 308, (such as, for example, in a main floor hallway or kitchen) which can facilitate convenient access to the housing 312. Wires can be provided for signal communication between the respective components (e.g. sensors, air pump) and the controller 324. For example, wires from the shell side pressure sensor, the valve solenoids, and the flow measuring device can be grouped together in a harness that can be plugged into a corresponding receptacle in the housing 312 of the testing apparatus 310.

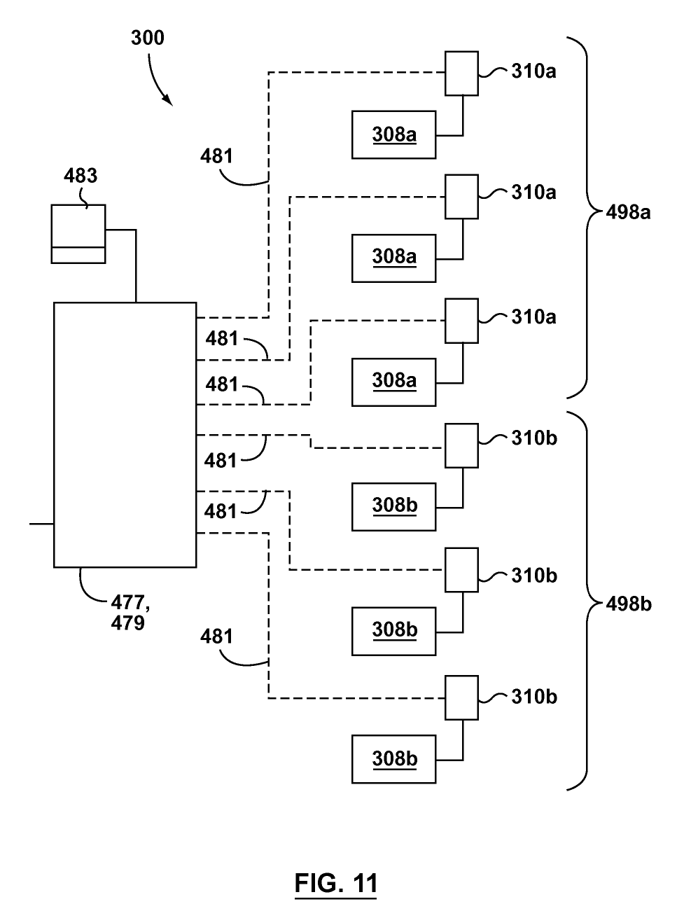

Referring to FIG. 11, the system 300 can further be configured for remote control operation of one or more of the testing apparatuses 310 and respective filtration assemblies 308. For example, the system 300 can include a remote service center 477 comprising a master controller 479. The service center 477 can be located geographically apart from the filtration assembly 308. The system 300 can include a communication circuit 481 for providing data communication between the master controller 479 and the controller (also called local controller) 324 of the testing apparatus 310. Each local controller 324 can include an interface for connecting to the communication circuit 481. The communication circuit 481 can comprise a telephone connection, cable connection, T4, wireless, or other communication connection. The interface at the local controller 324 can comprise, for example, a port, jack, or wireless card.

The service center 477 can send a “start” signal to the local controller 324 to initiate the testing procedure, including the drainage and depressurizing of the filter unit 414, and running the test algorithm. The automatically activated testing procedure can be performed during typically low water requirement periods, such as in the middle of the night.

The host controller 479 can also monitor the test results, for example, to detect trends in the results of successive tests. Successive tests may, for example, each result in a pass, but may show a trend that if allowed to continue unchecked, would eventually result in a failure reading for one or more of the acceptance criteria. Monitoring the trends can facilitate providing pre-emptive service, prior to any failure of the system, thereby avoiding potential harm caused by inadequate filtration of water distributed, for example, immediately prior to a “failed” test.

The master controller 479 can also be connected to a workstation 483, through which personnel can manually send a “start test” signal to one or more of the filtration assemblies. For example, local health authorities may issue a “boil water” alert for a certain geographical area in response to a particular threat. Personnel could send a “start test” signal from the master controller 479 via the host workstation 483 to a group of filtration assemblies 498a located in the affected area. Upon passing the test, users could be confident of satisfactory filtration.

Upon receiving a “failed test” signal from a local controller 324, the service center 477 can send out a response signal to, for example, a service technician to dispatch the service technician to a particular filtration assembly. Response signals can be sent automatically from the master controller 479 via telephone using pre-recorded messages, via e-mail, pages, or other communication modes. Response signals can also be sent to users of the filtration assemblies (e.g. home owners) to alert the users of any potential problems with their water systems 300.

Some or all of the signal processing functions performed by the local controllers 324 can be carried out by the master controller 479. In some examples, the local controllers 324 can comprise a data communication interface with little or no decision-making capability at the local level. The master controller 479 can receive signals from the sensors, and can compare the signals to acceptance criteria stored in the master controller, and/or to test-triggering criteria stored in the master controller.

The service center 477 can also establish new (or modify existing) parameters for the testing apparatus 310, such as the pre-selected acceptance criteria or the test-triggering criteria. The steps followed in the testing procedure, including, but not limited to, Parts A and B of the test algorithm, can also be changed by the service center 477.

While the above description provides examples of one or more processes or apparatuses, it will be appreciated that other processes or apparatuses may be within the scope of the accompanying claims.

We claim:

1. A testing apparatus for testing the integrity of membranes in a water treatment unit, comprising:
a) a pressurized gas supply element for pressurizing one side of membranes of a water treatment unit;
b) a pressure sensor in communication with the gas on said one side of the membranes for sensing the pressure thereof;
c) a controller in communication with the pressure sensor for comparing signals from the pressure sensor to pre-selected acceptance criteria; and
d) an output device in communication with the controller for signaling results of the comparison.

2. The apparatus of claim 1, further comprising a housing, at least the pressurized gas supply element and the controller being housed in the housing.

3. The apparatus of claim 2, wherein the pressurized gas supply element comprises an air pump.

4. The apparatus of claim 3, wherein the pump is switchable between on and off positions by electrical communication from the controller.

5. The apparatus of claim 4, wherein the controller includes a stored algorithm, execution of which is triggered by an initiate signal sensed by the controller.

6. The apparatus of claim 5, wherein the algorithm includes turning the pump off and sensing the pressure at least before and after a time interval, and the acceptance criteria includes comparing the difference between the before and after pressures to a maximum allowable pressure drop.

7. The apparatus of claim 6 wherein the algorithm includes, prior to turning the pump off, turning the pump on and sensing the pressure at least once to confirm satisfactory pressurization of said one side of the membranes.

8. A method for providing treated water in multiple homes or buildings using membrane filtration, the method comprising:
a) installing respective ones of a plurality of filtration assemblies at respective ones of a plurality of water service entry points, the filtration assemblies including porous membranes through which water is directed;
b) providing an integrity tester apparatus, the tester apparatus connectable to any one of the plurality of filtration assemblies; and
c) connecting the integrity test apparatus one at a time to each of the plurality of filtration assemblies to test the integrity of the membranes.

9. The method of claim 8, wherein the respective ones of the plurality of water service entry points are remote from each other, and wherein step c) includes transporting the tester apparatus between each of the water service entry points.

10. The method of claim 8, wherein the tester apparatus includes an integral air pump, and step c) includes releasably coupling the air pump to the respective ones of the plurality of filtration systems to provide pressurized gas on one side of the membranes.

11. A system for providing a plurality of water service entry points with filtration assemblies and testing the integrity thereof, comprising:
a) a plurality of filtration assemblies, each assembly adapted for installation at a respective water service entry point, each filtering unit having porous membranes; and
b) an integrity test apparatus releasably connectable to any one of the plurality of filtration assemblies to test the integrity of the membranes.

12. The system of claim 11, wherein the integrity test apparatus is portable.

13. A system for providing a plurality of water service entry points with filtration assemblies and testing the integrity thereof, comprising:
a) a plurality of filtration assemblies, each filtration assembly having porous membranes through which feed water from a respective water supply line is passed;
b) a plurality of integrity test apparatuses, each integrity test apparatus coupled to a respective one of the filtration assemblies for testing the integrity of the membranes; and
c) a master controller coupled to each one of the integrity test apparatuses.

14. The system of claim 13 wherein each one of the integrity test apparatuses comprises a local controller having an interface for communication with the master controller.

15. The system of claim 14 wherein each one of the integrity test apparatuses comprises a respective pressure sensor for sensing pressure on a first side of the membranes, the respective pressure sensor in communication with the respective local controller.

16. The system of claim 15 wherein each one of the integrity test apparatuses comprises a respective gas supply element for pressurizing the first side of the membranes in response to a signal received from the respective local controller.

17. The system of claim 16 wherein each one of the filtration assemblies comprises at least one valve movable between first and second positions in response to a signal received from the respective local controller.

18. The system of claim 17 wherein instructions for receiving signals from the respective pressure sensor and for sending signals to the gas supply element and at least one valve are stored in each respective local controller.

19. The system of claim 18 wherein test acceptance criteria is stored in each respective local controller for comparison to signals received from the respective pressure sensor.

20. The system of claim 18 wherein test triggering criteria is stored in each respective local controller for initiating execution of the steps of the test procedure.
